(19) United States
(12) Patent Application Publication
(10) Pub. No.: US 2010/0182377 A1
(43) Pub. Date: Jul. 22, 2010

(54) LIQUID EJECTING HEAD, LIQUID EJECTING HEAD UNIT, METHOD FOR FABRICATING THE SAME, AND LIQUID EJECTING APPARATUS

(75) Inventors: Hiroyuki HAGIWARA, Suwa-shi (JP); Noriaki OKAZAWA, Shiojiri-shi (JP); Satoshi OGUCHI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/689,851

(22) Filed: Jan. 19, 2010

(30) Foreign Application Priority Data
Jan. 20, 2009 (JP) 2009-010389

(51) Int. Cl. B41J 2/14; B41J 2/16

(52) U.S. Cl. 347/47; 29/890.1

(57) ABSTRACT

A method for fabricating a liquid ejecting head unit including a liquid ejecting head having a nozzle line with a plurality of nozzle openings which are arranged in parallel, and a base plate on which the liquid ejecting head is mounted, the method includes: forming a second reference which is positioned to a first reference installed on the base plate, and a positioning adjusting hole on a positioning plate by a photolithographic method; attaching the positioning plate to the liquid ejecting head in such a way that the positioning adjusting hole and the nozzle openings have a predetermined arrangement; and fixing the liquid ejecting head to the base plate in a state in which the first reference and the second reference are positioned.

### BACKGROUND

1. Technical Field

The present invention relates to a liquid ejecting head, a liquid ejecting head unit, a method for fabricating the same, and a liquid ejecting apparatus, and more particularly, to an ink jet type recording head capable of ejecting ink as a liquid, an ink jet type recoding head unit, a method for fabricating the same, and an ink jet type recording apparatus.

2. Related Art

A liquid ejecting apparatus which is represented by an ink jet type recording apparatus, such as an ink jet type printer or a plotter, includes a liquid ejecting head unit (hereinafter, referred to as a head unit) provided with a plurality of liquid ejecting heads that can eject a liquid, such as ink filled in a cartridge or a tank, as droplets.

The plurality of liquid ejecting heads are placed on a base plate which serves as a common retaining member, and the plurality of liquid ejecting heads are disposed in such a way that nozzle lines formed by nozzle openings, which are arranged in the respective liquid ejecting heads, are continuous in a parallel-arranged direction.

In order to improve the precision of shot positions of the liquid, each of the liquid ejecting heads needs to be attached to a base plate after the positions of the nozzle openings are positioned with high precision. A method for positioning the liquid ejecting head includes a technique (e.g., see JP-A-2003-57430 (claim 4, paragraph 25 and the like)) for moving a parallel plate spring by driving an actuator device to align a liquid ejecting head with a predetermined reference position, and a technique (e.g., see JP-A-2008-36512 (paragraphs 86 to 111 and the like)) for fixing a liquid ejecting head to a base plate or the like to an alignment mark by using, for example, an image recognizing device having a camera or the like, in which the alignment mark is installed on a glass mask or the like and is set as a reference.

However, since the positioning is performed by an adjustment mechanism, such as the actuator device, the parallel plate spring or the like, in the technique disclosed in JP-A-2003-57430, there is a problem in that the positioning is not performed with high precision. In addition, the technique disclosed in JP-A-2008-36512 requires effort and time in the position adjustment for positioning the plurality of liquid ejecting heads to the alignment mark.

In this instance, such problems similarly occur in the liquid ejecting head unit that ejects liquid other than the ink, as well as the ink jet type recording head unit.

### SUMMARY

An advantage of some aspects of the invention is that there are provided a liquid ejecting head which can be positioned easily and highly accurately, a liquid ejecting head unit, a method for fabricating the same, and a liquid ejecting apparatus.

According to an aspect of the invention, there is provided a method for fabricating a liquid ejecting head unit including a liquid ejecting head having a nozzle line with a plurality of nozzle openings which are arranged in parallel, and a base plate on which the liquid ejecting head is mounted, the method including forming a second reference which is positioned to a first reference installed on the base plate, and a positioning adjusting hole on a positioning plate by a photolithographic method; attaching the positioning plate to the liquid ejecting head in such a way that the positioning adjusting hole and the nozzle openings have a predetermined arrangement; and fixing the liquid ejecting head to the base plate in a state in which the first reference and the second reference are positioned.

In this aspect, a relative position between the nozzle openings and the second reference is defined with high precision through the positioning adjusting hole formed in the positioning plate by the photolithographic method. In addition, the second reference is positioned to the first reference. Consequently, the nozzle openings are arranged with high precision at a position spaced a predetermined distance from the first reference when seen from a plane of the nozzle openings side of the liquid ejecting head unit. As such, since the nozzle openings can be arranged with high precision at the predetermined position of the base plate, there is provided a liquid ejecting head unit of which the ejecting characteristic of the droplets is excellent. Further, since the nozzle openings of the liquid ejecting head are arranged with high precision at the predetermined position of the base plate only by positioning the second reference to the first reference, alignment of the liquid ejecting head can be conveniently performed with high precision.

Here, it is preferable that in the step of attaching the positioning plate, the plurality of positioning plates are respectively attached to the plurality of liquid ejecting heads, and in the step of fixing the liquid ejecting head, the liquid ejecting head is fixed to the base plate in the state in which the second reference is positioned to each of the plurality of first references installed on the base plate. As a result, a relative position between the plurality of liquid ejecting heads can be retained to arrange the nozzle openings of the respective liquid ejecting heads with high precision.

Further, it is preferable that in the step of forming the second reference and the positioning adjusting hole, two positioning adjusting holes are formed in an edge portion of the positioning plate by the photolithographic method so that the positioning adjusting holes are opposite to each other across a center of the positioning plate. As a result, it is easy to recognize a slope of a straight line connecting the positioning adjusting holes. Consequently, when the positioning adjusting hole and the nozzle openings are aligned, it is easy to correct the slope of the positioning plate.

In addition, it is preferable that the first reference is a positioning pin installed on a surface of the base plate, and in the step of forming the second reference and the positioning adjusting hole, a through-hole inscribed in an outer circumference of the positioning pin is formed as the second reference in the positioning plate, in which the positioning adjusting hole is formed to have a diameter narrower than that of the through-hole. As a result, the positioning adjusting hole of the positioning plate and the nozzle openings can be positioned with high precision by use of a CCD camera.

Further, it is preferable that in the step of forming the second reference and the positioning adjusting hole, a surface abutting against the first reference is formed as the second reference on the positioning plate. As a result, the second reference can be aligned to the first reference by abutting the second reference against the first reference. More conveniently, the liquid ejecting head can be positioned to the base plate.

According to another aspect of the invention, there is provided a liquid ejecting head having a nozzle line with a plurality of nozzle openings which are arranged in parallel, the liquid ejecting head including: a positioning plate in which a second reference which is positioned to a first reference installed on a base plate, and a positioning adjusting hole are formed by a photolithographic method, wherein the positioning adjusting hole and the nozzle openings of the positioning plate have a predetermined arrangement.

In this aspect, a relative position between the nozzle openings and the second reference is defined with high precision through the positioning adjusting hole formed in the positioning plate by the photolithographic method. Moreover, the second reference is positioned to the first reference installed on the base plate. Consequently, if the liquid ejecting head is attached to the base plate, the nozzle openings are positioned with high precision at a position spaced a predetermined distance from the first reference when seen from a plane of the nozzle openings side of the liquid ejecting head unit. As such, with the liquid ejecting head according to the aspect, the nozzle openings can be arranged with high precision to the base plate. Additionally, since the nozzle openings of the liquid ejecting head are arranged with high precision at the predetermined position of the base plate only by positioning the second reference to the first reference, the alignment of the liquid ejecting head can be conveniently performed with high precision.

Furthermore, according to another aspect of the invention, there is provided a liquid ejecting head unit including the plurality of liquid ejecting heads of the above aspect which are mounted on the base plate.

In this aspect, a relative position between the nozzle openings and the second reference is defined with high precision through the positioning adjusting hole formed in the positioning plate by the photolithographic method. In addition, the second reference is positioned to the first reference. Consequently, the nozzle openings are arranged with high precision at a position spaced a predetermined distance from the first reference when seen from a plane of the nozzle openings side of the liquid ejecting head unit. As such, since the nozzle openings can be arranged with high precision to the base plate, the liquid ejecting head unit of the invention has an excellent droplet ejecting characteristic. Further, since the nozzle openings of the liquid ejecting head are arranged with high precision at the predetermined position of the base plate only by positioning the second reference to the first reference, alignment of the liquid ejecting head with respect to the base plate of the liquid ejecting head can be conveniently performed with high precision.

In addition, according to another aspect of the invention, there is provided a liquid ejecting apparatus including the liquid ejecting head unit according to the above aspect.

In this aspect, there is provided the liquid ejecting apparatus capable of positioning the liquid ejecting head with easy and high precision.

Furthermore, according to another aspect of the invention, there is provided a method for fabricating a liquid ejecting head having a nozzle line with a plurality of nozzle openings which are arranged in parallel, the method including forming a second reference which is positioned to a first reference installed on a base plate, on which the liquid ejecting head is mounted, and a positioning adjusting hole on a positioning plate by a photolithographic method; and attaching the positioning plate to the liquid ejecting head so that the positioning adjusting hole and the nozzle openings have a predetermined arrangement.

In this aspect, there is provided the liquid ejecting head which can be attached to the base plate with ease and high precision.

### BRIEF DESCRIPTION OF THE DRAWINGS

The invention will be described with reference to the accompanying drawings, wherein like numbers reference like elements.

FIG. 1 is a perspective view schematically showing an ink jet type recording head unit according to a first embodiment.

FIG. 2 is a plan view of the ink jet type recording head unit according to the first embodiment.

FIG. 3 is a perspective view schematically showing an ink jet type recording head according to the first embodiment.

FIG. 4 is a cross-sectional view taken along line IV-IV in FIG. 2.

FIGS. 5A to 5C are schematic views illustrating a method for fabricating a head unit according to the first embodiment.

FIG. 6 is a plan view of the ink jet type recording head unit according to a second embodiment.

FIG. 7 is a perspective view schematically showing an ink jet type recording head according to a second embodiment.

FIG. 8 is a cross-sectional view taken along line VIII-VIII in FIG. 6.

FIGS. 9A and 9B are schematic views illustrating a method for fabricating a head unit according to the second embodiment.

### DESCRIPTION OF EXEMPLARY EMBODIMENTS

The invention will now be described in detail based on embodiments.

### First Embodiment

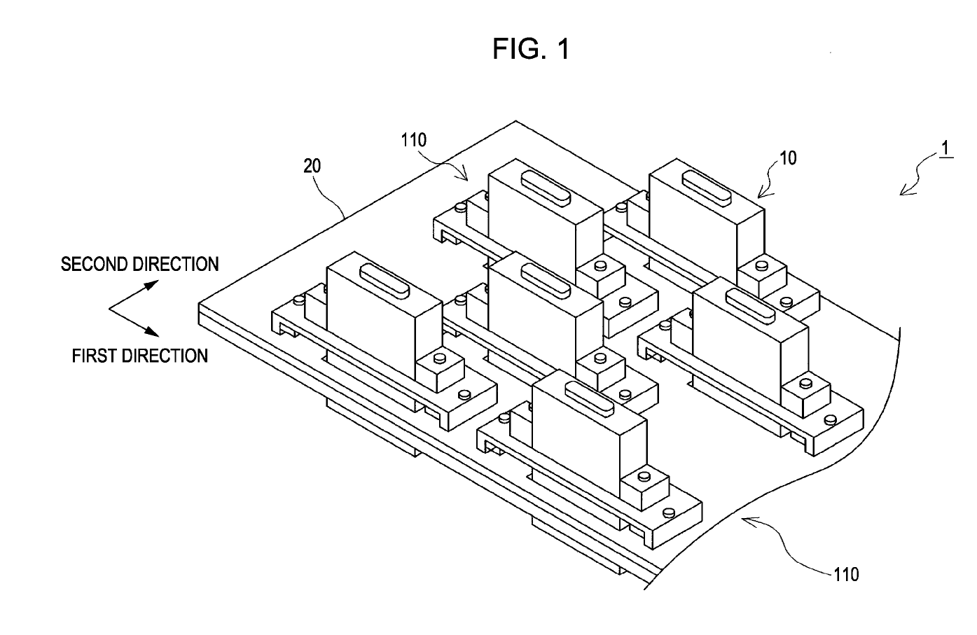

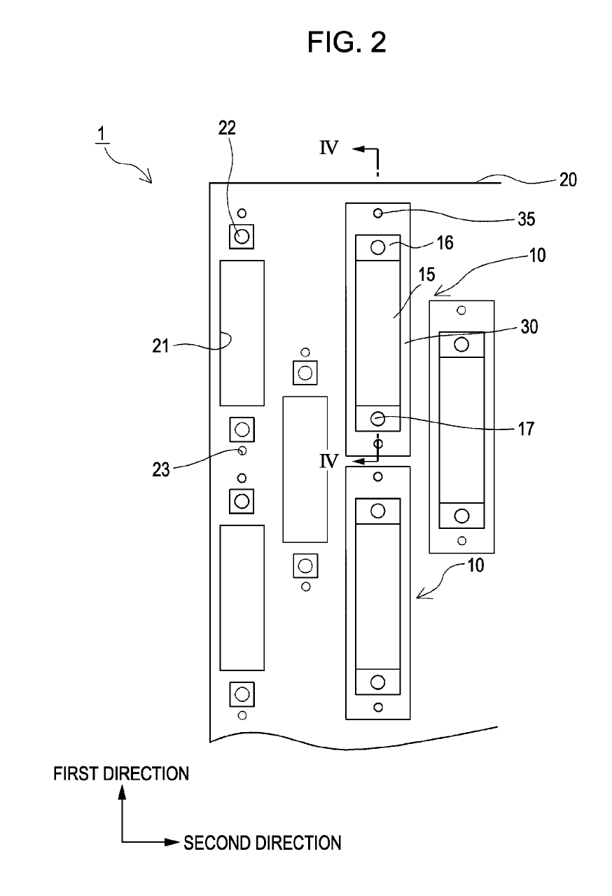

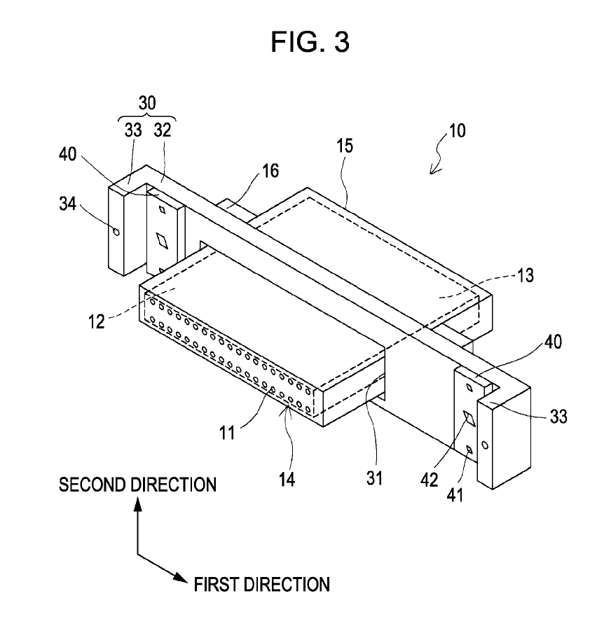

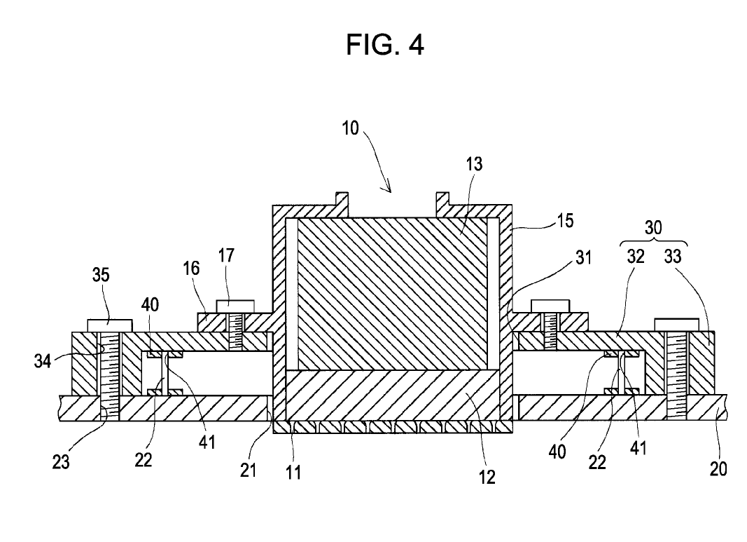

FIG. 1 is a perspective view schematically showing an ink jet type recording head unit which is an example of a liquid ejecting head unit according to a first embodiment. FIG. 2 is a plan view of the ink jet type recording head unit according to the first embodiment. FIG. 3 is a perspective view schematically showing an ink jet type recording head which is an example of a liquid ejecting head according to the first embodiment. FIG. 4 is a cross-sectional view taken along line IV-IV in FIG. 2.

As shown in FIG. 1, an ink jet type recording head unit 1 (hereinafter, referred to as a head unit) according to the embodiment includes a base plate 20 on which a plurality of ink jet type recording heads 10 (hereinafter, referred to as a head) are placed.

As shown in FIGS. 1 and 2, in the base plate 20, one head 10 is provided with one through-hole 21, respectively, in which the through-hole penetrates the head in a thickness direction. Each of the heads 10 is fixed to the base plate through a sub-plate 30, in the state in which the head 10 is penetrated by the through-hole 21.

The through-hole 21 is formed as an opening slightly larger than an outer circumference of a head case 15 of the head 10 and smaller than the sub-plate 30. For this reason, if the head 10 is inserted into the through-hole 21, the sub-plate 30 of the head 10 is retained on the base plate 20. Further, since a gap is created between the head 10 and the through-hole 21, the head 10 can be slightly moved in a first direction and a second direction with respect to the base plate 20.

Further, the base plate 20 is provided with a positioning pin 22, which is one example of a first reference, at a predetermined position of the base plate 20. That is, as discussed in more detail below, when the positioning pin 22 is fitted to a positioning pin inserting hole 42, which is an example of a second reference, formed in the head 10, each of the positioning pins 22 is installed in the base plate 20 so that the relative positions of the plurality of heads 10 are arranged in a predetermined way. In this embodiment, each positioning pin 22 is formed on both sides of the respective through-holes 21, respectively, so that the relative positions thereof are arranged at a predetermined way. In this instance, the base plate 20 is provided with a fixing screw hole 23 to which a fixing screw 35 for fixing the sub-plate 30 of the head 10 is threadably engaged.

As shown in FIGS. 3 and 4, the head 10 of the embodiment includes a head body 12 with nozzle openings 11 formed in one end surface thereof, a flow channel member 13 fixed to an end surface opposite to the nozzle openings 11 of the head body 12, a head case 15 housing the head body and the flow channel member, and the sub-plate 30 that attaches the head case 15 to the base plate 20.

The head body 12 includes nozzle lines 14 with the nozzle openings 11 arranged in parallel. The number of the nozzle lines 14 is not particularly limited, but, for example, one row or plural rows of at least two rows may be employed. In this embodiment, one head body 12 is provided with two rows of nozzle lines 14. In the nozzle lines 14 according to the embodiment, a parallel-arranged direction of the nozzle openings 11 is referred to as a first direction, while a direction intersecting with the first direction is referred to as a second direction. Consequently, 2 rows of nozzle lines 14 are arranged in parallel in the second direction.

In this instance, although not shown in the figure, the head body 12 is provided therein with a pressure generating chamber constituting a portion of a flow channel which communicates with the nozzle openings 11, and a pressure generating member that creates pressure variation in the pressure generating chamber to eject ink from the nozzle openings.

The pressure generating member may employ, but is not limited to, for example, a member using a piezoelectric element which indicates an electromechanical switching function and is sandwiched between two electrodes, a member in which a heater element is disposed in the pressure generating chamber to eject droplets from the nozzle openings 11 by bubbles created by heat generation of the heater element, or a member which generates static electricity between a vibration plate and an electrode to deform the vibration plate and thus jet droplets from the nozzle openings 11. Further, as the piezoelectric element, a piezoelectric element of a flexural vibration type which is stacked by a lower electrode, a piezoelectric material from the pressure generating chamber side and a top electrode and is subjected to flexural deformation, a piezoelectric element of a longitudinal vibration type which is alternatively stacked by a piezoelectric material and an electrode forming material and is expanded and contracted in an axial direction, or the like may be used.

The flow channel member 13 is fixed to a surface opposite to the nozzle openings 11 of the head body 12 to supply the ink from the exterior to the head body 12 or discharge the ink from the head body 12 to the exterior. The flow channel member 13 is provided with a liquid channel port (not shown) at a surface opposite to the surface to which the head body 12 is fixed, the liquid flow channel port formed by opening an internal flow channel and being connected to an external flow channel, and a connector (not shown) that receives an electric signal, such as a print signal, from the exterior.

The head case 15 receives the head body 12 and the flow channel member 13 therein. Additionally, the head case 15 is provided with flange portions 16 which protrudes outwardly, at both sides thereof in the first direction, and the flange portions 16 are fixed to the sub-plate 30 by head case fixing screws 17.

The sub-plate 30 is a member for attaching the head case 15 to the base plate 20. More specifically, the sub-plate 30 is constituted by a base portion 32 provided with a head inserting hole 31, and a leg portion 33 installed at one side of the base portion 32.

The flange portion 16 of the head case 15 is fixed to the base portion 32 of the sub-plate 30, in the state in which the head case 15 is inserted in the head inserting hole 31. In addition, the leg portion 33 of the sub-plate 30 is provided with a fixing screw receiving hole 34 penetrating the leg portion in a thickness direction thereof. In the state in which the fixing screw 35 is inserted in the fixing screw receiving hole 34, the sub-plate 30 is fixed to the base plate 20 by threadably engaging the fixing screw to the fixing screw hole 23. In this instance, the fixing screw receiving hole 34 has a diameter slightly larger than that of the fixing screw 35, so that the sub-plate 30 is slightly movable in the first direction and the second direction. This is to finely adjust the position of the sub-plate 30 with respect to the base plate 20, when the positioning pin 22 is fitted into a positioning pin inserting hole 42 formed in a positioning plate 40 which will be described below.

The sub-plate 30 is provided with two sheets of positioning plates 40 each attached to both sides of the base portion 32 at a surface of the nozzle opening 11 side, with the through-hole 21 being interposed between the positioning plates 40. The positioning plate 40 is made of a silicon substrate, and is provided with a positioning adjusting hole 41 and a positioning pin inserting hole 42 which is an example of a second reference.

The positioning pin inserting hole 42 is a hole to which the positioning pin 22 installed on the base plate 20 is fitted. The positioning adjusting hole 41 is a hole used for the positioning when the positioning plate 40 is attached to the sub-plate 30, which will be described in detail.

Since the positioning adjusting hole 41 and the positioning pin inserting hole 42 are formed by a photolithographic method, the positioning adjusting hole and the positioning pin inserting hole are highly accurately formed at predetermined positions of the positioning plate 40 with a dimensional tolerance smaller than that of the case, for example, in which a positioning plate is formed by injection molding of resin.

The positioning plate 40 is attached to the sub-plate 30 in the state in which the positioning adjusting hole 41 and the nozzle openings 11 are positioned at predetermined positions. Here, the state, in which the positioning adjusting hole 41 and the nozzle openings 11 are positioned at the predetermined positions, means that the positioning adjusting hole 41 is positioned at a position spaced a predetermined distance from the nozzle openings 11 in the first direction and the second direction in a plan view of the head 10 which is seen from the nozzle openings 11.

Since the positioning adjusting hole 41 and the nozzle openings 11 are positioned at the predetermined positions and the positioning adjusting hole 41 and the positioning pin inserting hole 42 are highly accurately formed at the predetermined positions of the positioning plate 40 by the photolithographic method, as described above, the relative position between the positioning pin inserting hole 42 and the nozzle openings 11 is defined with high precision. That is, the positioning pin inserting hole 42 is highly precisely positioned at a position spaced a predetermined distance from the nozzle openings 11 in the first direction and the second direction in a plan view of the head 10 which is seen from the nozzle openings 11.

In this embodiment, one positioning pin inserting hole 42 is formed at the center of the positioning plate 40, and one positioning adjusting hole 41 is formed in both sides of the positioning plate 40, respectively, in the state in which the center of the positioning plate 40 is interposed between the positioning adjusting holes 41.

In order to form the positioning pin inserting hole 42 and the positioning adjusting hole 41 at the predetermined positions, a photoresist pattern is formed on the positioning plate 40, and then is subjected to etching, thereby forming the positioning plate 40. In this instance, the positioning plate 40 is made of silicon in this embodiment, but the material is not particularly limited thereto if the positioning adjusting hole 41 and the positioning pin inserting hole 42 can be formed by a photolithographic method. As such material, there are metals such as SUS or glass.

The head 10 attached with the positioning plate 40 as described above is fixed to the base plate 20 by the fixing screw 35 in the state in which the positioning pin inserting hole 42 which is the second reference is positioned to the positioning pin 22 which is the first reference.

Here, the state in which the second reference is positioned to the first reference means that the position of the second reference is defined by restricting movement of the second reference by the first reference. In this embodiment, the movement of the positioning pin 22 in the first direction and the second direction is restricted by fitting the positioning pin 22 to the positioning pin inserting hole 42, and thus, the position of the positioning pin inserting hole 42 is defined.

In this instance, the positioning pin inserting hole 42 is formed in the shape of a rhombic opening, and the traverse cross section of the positioning pin 22 is formed in a circular shape inscribed in the opening shape of the positioning pin inserting hole 42. Consequently, since there is no allowance between the positioning pin inserting hole 42 and the positioning pin 22, it is possible to more surely position the positioning pin inserting hole 42 and the positioning pin 22.

If the positioning pin inserting hole 42 is positioned to the positioning pin 22 as described above, the nozzle openings 11 of the head 10 are highly precisely arranged at predetermined positions of the base plate 20. That is, the nozzle openings 11 of the head 10 are highly precisely positioned in the predetermined arrangement when seen at a plane of the nozzle openings 11 side of the head unit 1.

That is, the relative position between the nozzle openings 11 and the positioning pin inserting hole 42 is defined with high precision by the positioning adjusting hole 41 of the positioning plate 40 formed by the photolithographic method, as described above. Further, the positioning pin inserting hole 42 is positioned to the positioning pin 22. Accordingly, the nozzle openings 11 are arranged with high precision at a position spaced a predetermined distance from the positioning pin 22 in the first direction and the second direction when seen at a plane of the nozzle openings 11 side of the head unit 1.

Further, since the positioning pin 22 is installed at the base plate 20 in such a way that the relative position of the respective heads 10 has a predetermined arrangement, the nozzle openings 11 of the respective heads 10 are arranged while maintaining a relative interval between the heads 10.

In this embodiment, the respective heads 10 are arranged at the predetermined position, as described below. That is, as shown in FIG. 1, a head group 110 is formed by disposing the plurality of heads 10 in the first direction which is a parallel-arranged direction of the nozzle openings 11 in the nozzle line 14 of the head 10 (see FIG. 3), and four head groups 110 are arranged in parallel in the second direction. That is, the heads 10 are disposed in plural in the first direction and the second direction.

More specifically, the plurality of heads 10 is disposed in a zigzag pattern in the first direction so that the nozzle lines 14 are continuous in the first direction. Two head groups 110 constituting by the plurality of heads 10, which are disposed in such a way that the nozzle lines 14 are continuous in the first direction, are arranged in parallel in the second direction.

Here, the state in which the nozzle lines 14 of the respective head groups 110 are continuous in the first direction means that the nozzle openings 11 of the end of the nozzle line 14 of one head 10 and the nozzle openings 11 of the end of the nozzle lines 14 of the other head 10 are disposed to be positioned at the same position in the first direction in the neighboring heads 10 of the respective head group 110 in the second direction.

As such, since the nozzle lines 14 of the plurality of heads 10 are disposed to be continuous in the first direction in the respective head groups 110, extensive printing can be performed at high speed as compared with the case of performing the printing by nozzle lines 14 of one head 10.

As described above, the head 10 according to the embodiment includes the nozzle openings 11 which are disposed with high precision in the positioning pin inserting hole 42 through the positioning adjusting hole 41. For this reason, if the head 10 is attached to the base plate 20, the nozzle openings are positioned with high precision at the position spaced a predetermined distance from the positioning pin 22 installed at the base plate 20, when seen at a plane of the nozzle openings 11 side of the head unit 1.

Further, the head unit 1 according to the embodiment has an excellent ejection characteristic of the ink droplets, since the nozzle openings 11 are arranged with high precision at the predetermined position of the base plate 20. That is, there is provided the head unit 1 of which the precision of the shot position of the ink droplets is improved. Moreover, simply by fitting the positioning pin 22 into the positioning pin inserting hole 42 and fixing the head 10 to the base plate 20 by the fixing screw 35, the nozzle openings 11 of the head 10 are arranged with high precision at the predetermined position of the base plate 20. That is, the alignment of the head 10 can be conveniently performed without spending labor or time to match the nozzle openings 11 of the head 10 and the predetermined position of the base portion 20 by use of a CCD camera or the like.

In addition, the head unit 1 according to the embodiment does not require an actuator device or a parallel plate spring as a mechanism for positioning the nozzle openings 11 of the head 10 at the predetermined position of the base plate 20. As a result, it is possible to promote the downsizing and the cost reduction in the head unit 1. Additionally, when the head 10 is replaced on the spot where a liquid ejecting apparatus including the head unit 1 is actually used, the head 10 alone can be positioned with high precision, and then be individually replaced, without changing the head unit 1.

In this instance, the head 10 according to the embodiment includes the sub-plate 30, but is not limited to this aspect. The head can be fixed by directly attaching the positioning plate 40 to the head case 15 and then positioning the head case 15 to the base plate 20.

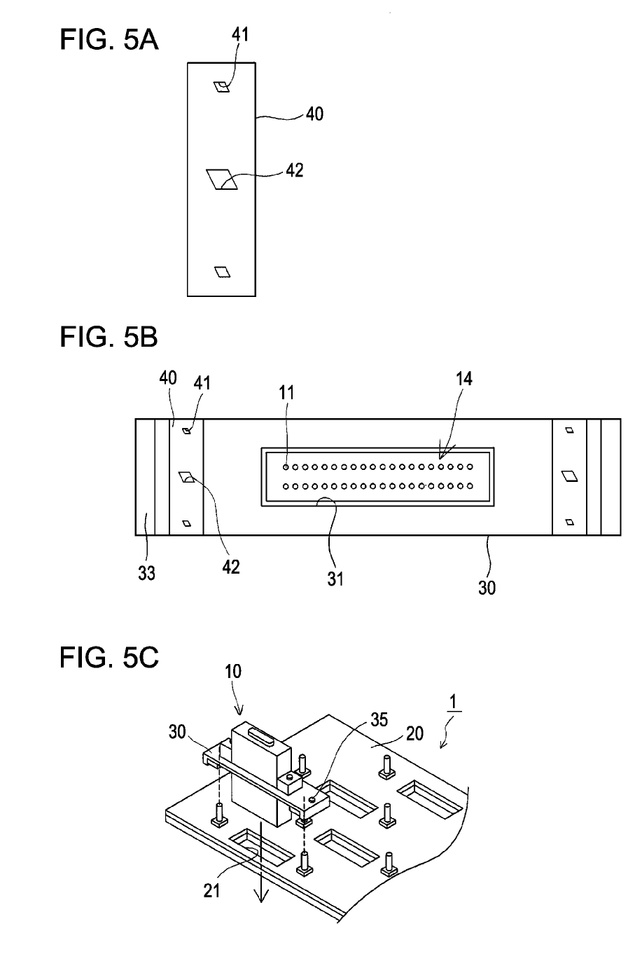

Next, a method for fabricating the head 10 and the head unit 1 according to the embodiment will now be described. FIGS. 5A to 5C are schematic views illustrating the method of fabricating the head and the head unit according to the first embodiment of the invention.

First, as shown in FIG. 5A, a photoresist pattern is formed on the surface of the positioning plate 40 in order to form the positioning adjusting hole 41 and the positioning pin inserting hole 42 at the predetermined positions, and then is etched. After that, the photoresist pattern is removed to form the positioning adjusting hole 41 and the positioning pin inserting hole 42 in the positioning plate 40.

In this embodiment, the positioning pin inserting hole 42 is formed in a circular shape in such a way that the positioning pin 22 is inscribed in the positioning pin inserting hole 42. Further, in one sheet of the positioning plate 40, two positioning adjusting holes 41 in total are formed opposite to each other across the center thereof at the edge portion of the positioning plate 40. In addition, the positioning adjusting hole 41 is formed to have a diameter smaller than that of the positioning pin inserting hole 42.

Further, since two positioning plates 40 are attached to one head 10, double sheets of the positioning plates 40 of the head 10 are made. In this instance, it is not necessary to always attach plural sheets of the positioning plates 40 with respect to one head 10. For example, the positioning plate having a shape which can be attached to the entire surface of the leg 33 side of the base portion 32 of the sub-plate 30 may be provided with a through-hole which communicates with the positioning adjusting hole 41, the positioning pin inserting hole 42 and the head inserting hole 31 of the base portion 32, and the head 10 may be inserted into the through-hole.

Next, the head case 15 receiving the head body 12 and the flow channel member 13 is fixed to the sub-plate 30 by inserting the head case 15 into the head inserting hole 31, in the state in which the nozzle openings 11 side protrude toward the leg portion 33 side. As shown in FIG. 5B, the head 10 is formed by attaching the positioning plate 40 to the sub-plate 30 so that the positioning adjusting hole 41 and the nozzle openings 11 have a predetermined arrangement. More specifically, the CCD camera captures an image of the positioning adjusting hole 41 and the nozzle openings 11, and the centers of the positioning adjusting hole 41 and the nozzle openings 11 are obtained from the obtained image through an image process. The position of the positioning plate 40 is adjusted in order to position the centers of the positioning adjusting hole 41 and the nozzle openings 11 at predetermined positions.

Consequently, the positioning adjusting hole 41 and the nozzle openings 11 are positioned in the predetermined arrangement. Further, since the relative position between the positioning adjusting hole 41 and the positioning pin inserting hole 42 is formed with high precision by the photolithographic method, the nozzle openings 11 and the positioning pin inserting hole 42 are positioned with high precision in the predetermined arrangement.

In this instance, as described above, the positioning adjusting hole 41 of the positioning plate 40 has a diameter smaller than that of the positioning pin inserting hole 42. In this embodiment, the positioning adjusting hole 41 is formed to have a diameter substantially equal to that of the nozzle opening 11. For this reason, in the case in which the resolution of the CCD camera is low, it is possible to capture the entire image of the positioning adjusting hole 41 in the field of vision without zooming out. Therefore, the center of the positioning adjusting hole 41 can be detected with high precision by the image process.

This is caused by the reasons below. Since the opening is formed in the rhombic shape, the center of the positioning adjusting hole 41 is obtained by obtaining a point of intersection of diagonal lines of the rhombic shape in the image process. For this reason, the entire positioning adjusting hole 41 must be captured in the image obtained by the CCD camera. If the positioning adjusting hole 41 has the large diameter substantially equal to that of the positioning pin inserting hole 42, the CCD camera must be zoomed out in order to contain the entire positioning adjusting hole 41 in the field of vision. Accordingly, an object to be imaged is captured in one pixel of the image obtained after zooming out in the range which is wider than one pixel of the image obtained before zooming out. As a result, as the object is widely captured, an error in the center of the rhombic shape is increased.

However, in the method for fabricating the head 10 and the head unit 1 according to the invention, since the positioning adjusting hole 41 has a diameter smaller than that of the positioning pin inserting hole 42, it is not necessary to perform the maximum zooming out of the CCD camera. Consequently, the center of the positioning adjusting hole 41 can be detected with high precision, and the positions of the positioning adjusting hole 41 and the nozzle openings 11 are aligned based on the center, thereby positioning the positioning adjusting hole and the nozzle openings with more higher precision.

In this instance, although it can be imagined that the positioning pin inserting hole 42 has a small diameter and the positioning pin inserting hole 42 and the nozzle openings 11 are directly positioned, the positioning pin 22 is required to have thickness to some extent in order to ensure its strength, and thus the positioning pin inserting hole 42 is also required to have a large diameter. Therefore, it is difficult to align the position by the above method. According to the invention, however, it is possible to indirectly align the positioning pin inserting hole 42 and the nozzle openings 11 through the positioning adjusting hole 41.

Further, the positioning plate 40 is provided with one positioning adjusting hole 41 in each of both edge portions across the center thereof. That is, the positioning adjusting holes 41 are disposed on the surface of the positioning plate 40 in such a way that the distance between the positioning adjusting holes 41 is extended as much as possible. For this reason, when the positioning plate 40 is placed on the surface of the leg portion 33 side of the sub-plate 30, it is easy to recognize a slope of a straight line connecting the positioning adjusting holes 41 on the surface. Consequently, when the positioning adjusting hole 41 and the nozzle openings 11 are aligned, it is easy to correct the slope of the surface of the positioning plate 40.

Next, as shown in FIG. 5C, the base plate 20 is provided with the positioning pins 22 so that each of the heads 10 is positioned in the predetermined arrangement, and the positioning pin 22 is fitted into the positioning pin inserting hole 42 by inserting the nozzle openings 11 side of the head 10 into the through-hole 21. In this instance, the head 10 is fixed to the base plate 20 by using the fixing screw 35 to form the head unit 1. As a result, the nozzle openings 11 are arranged with high precision at the predetermined position of the base plate 20, and the nozzle openings 11 of the respective heads 10 are retained and arranged at the relative interval between the respective heads 10.

### Second Embodiment

The first embodiment illustrates the positioning pin 22 and the positioning pin inserting hole 42 to which the positioning pin 22 is fitted, as the first reference and the second reference, but the invention is not limited thereto. For example, the second reference may be a surface which can abut against the first reference.

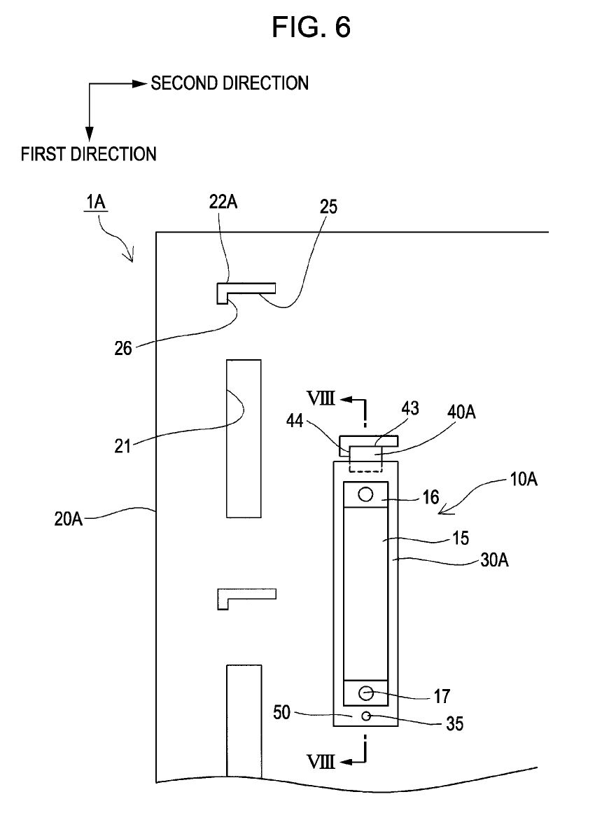

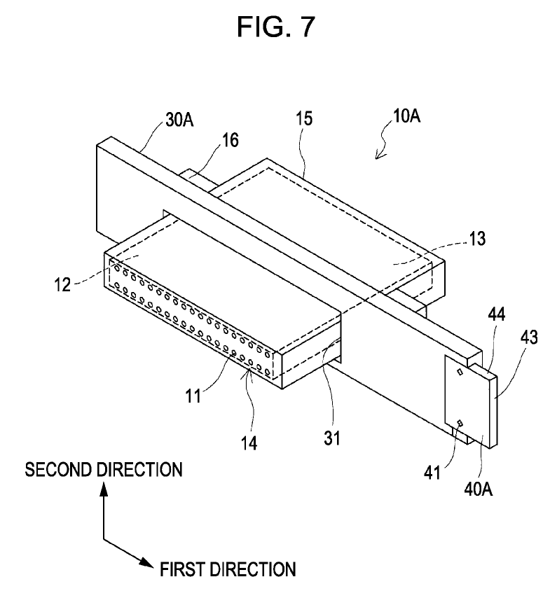

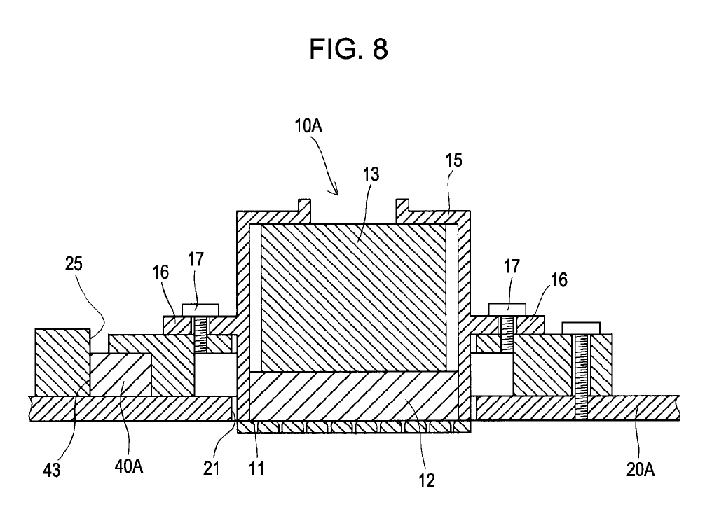

FIG. 6 is a plan view of the ink jet type recording head unit according to the second embodiment. FIG. 7 is a perspective view schematically showing an example of a liquid ejecting type recording head according to the second embodiment. FIG. 8 is a cross-sectional view taken along line VIII-VIII in FIG. 6. In this instance, components identical to those in the first embodiment are designated by the same reference numerals, and description thereof will be omitted herein.

As shown in FIG. 6, the base plate 20A is provided with a positioning convex portion 22A at one end side of one through-hole 21. The positioning convex portion 22A is formed in a substantially L-shape when viewed in a plan view, and has reference planes 25 and 26 which are a first reference. The reference plane 25 is a side facing a through-hole 21 of the positioning convex portion 22A, and is a plane parallel with the second direction. The reference plane 26 is a side facing the through-hole 21 of the positioning convex portion 22A, and is a plane parallel with the first direction.

The positioning convex portion 22A is installed on a base plate 20A in such a way that a relative position of a plurality of heads 10A has a predetermined arrangement when positioning planes 43 and 44 of a positioning plate 40A attached to the head 10A which will be described below abut against the reference planes 25 and 26, respectively.

As shown in FIGS. 6 and 8, a sub-plate 30A is a plate member having a head inserting hole 31 through which the head 10A is inserted, and one side of the sub-plate in its longitudinal direction is provided with the positioning plate 40A formed with the positioning plane 43 and the positioning plane 44 which are an example of the second reference.

The positioning plate 40A is formed with the positioning plane 43 and the positioning plane 44 by a photolithographic method. The positioning plane 43 means a side vertical to the first direction of the positioning plate 40A, and the positioning plane 44 means a side adjacent to the above side. Further, the positioning plane 43 and the positioning plane 44 are formed to abut against the reference planes 25 and 26 of the positioning convex portion 22A, respectively.

In addition, the positioning planes 43 and 44 are formed at a position where the positioning adjusting hole 41 formed in the positioning plate 40A is used as a reference. The predetermined position, in which the positioning adjusting hole 41 is used as a reference, means a position spaced a predetermined distance from the positioning adjusting hole 41 in the first direction and the second direction in a plan view, of which the head 10A is seen from the nozzle line 14 side, similar to the first embodiment.

The positioning plate 40A is attached to the sub-plate 30A in the state in which the positioning adjusting hole 41 and the nozzle openings 11 are positioned at predetermined positions. Here, the state, in which the positioning adjusting hole 41 and the nozzle openings 11 are positioned at the predetermined positions, means that the positioning adjusting hole 41 is positioned at a position spaced a predetermined distance from the nozzle openings 11 in the first direction and the second direction in a plan view of the head 10A which is seen from the nozzle openings 11.

Since the positioning adjusting hole 41 and the nozzle openings 11 are positioned at the predetermined positions and the positioning adjusting hole 41 and the positioning planes 43 and 44 are highly accurately formed at the predetermined positions of the positioning plate 40A by the photolithographic method, as described above, the relative position between the positioning planes 43 and 44 and the nozzle openings 11 is defined with high precision. That is, the positioning planes 43 and 44 are positioned with high precision at a position spaced a predetermined distance from the nozzle openings 11 in the first direction and the second direction in the plan view of the head 10A which is seen from the nozzle openings 11.

In order to allow the positioning planes 43 and 44 to appear at the predetermined position in which the positioning adjusting hole 41 is used as a reference, a photoresist pattern of a predetermined shape is formed on the positioning plate 40A, and then is subjected to etching, thereby forming the positioning planes 43 and 44.

The head 10A attached with the positioning plate 40A as described above is fixed to the base plate 20A by the fixing screw 35, by positioning the positioning planes 43 and 44 which are the second reference to the reference planes 25 and 26 which are the first reference.

Here, the state in which the second reference is positioned to the first reference means that the position of the second reference is defined by restricting movement of the second reference by the first reference. In this embodiment, the movement of the positioning plate 40 in the first direction and the second direction is restricted by abutting the positioning plane 43 against the reference plane 25, abutting the positioning plane 44 against the reference plane 26, and fixing the sub-plate 30A to the base plate 20A, and thus, the position of the positioning planes 43 and 44 is defined.

If the positioning planes 43 and 44 are positioned to the reference planes 25 and 26 as described above, the nozzle openings 11 of the head 10A are highly precisely arranged at a predetermined position of the base plate 20A. That is, the nozzle openings 11 of the head 10A are highly precisely positioned in the predetermined arrangement when seen at a plane of the nozzle openings 11 side of the head unit 1A.

That is, the relative position between the nozzle openings 11 and the positioning planes 43 and 44 is defined with high precision by the positioning adjusting hole 41 of the positioning plate 40A formed by the photolithographic method, as described above. Additionally, the positioning planes 43 and 44 are positioned to the reference planes 25 and 26. Accordingly, the nozzle openings 11 are arranged with high precision at a position spaced a predetermined distance from the reference plane 25 in the first direction and at a position spaced a predetermined distance from the reference plane 26 in the second direction, when seen at a plane of the nozzle openings 11 side of the head unit 1A.

Further, since the positioning convex portion 22A is installed at the base plate 20A in such a way that the relative position of the respective heads 10A has a predetermined arrangement, the nozzle openings 11 of the respective heads 10A are arranged while maintaining a relative interval between the heads 10A.

As described above, the head 10A and the head unit 1A according to the embodiment have the same effect as that of the head 10 and the head unit 1 according to the first embodiment. That is, in the head 10A according to the embodiment, the nozzle openings 11 are disposed with high precision on the positioning planes 43 and 44 through the positioning adjusting hole 41. For this reason, if the head 10A is attached to the base plate 20, the nozzle openings 11 are positioned with high precision at the position spaced a predetermined distance from the positioning planes 25 and 26 installed at the base plate 20, when seen at a plane of the nozzle openings 11 side of the head unit 1A.

Further, the head unit 1A according to the embodiment has an excellent ejection characteristic of the ink droplets, since the nozzle openings 11 are arranged with high precision at the predetermined position of the base plate 20A. That is, there is provided the head unit of which the precision of the shot position of the ink droplets is improved. Furthermore, only by abutting the positioning planes 43 and 44 against the reference planes 25 and 26 and fixing the head 10A to the base plate 20A by the fixing screw 35, the nozzle openings 11 of the head 10A are arranged with high precision at the predetermined position of the base plate 20A. That is, the alignment of the head 10A can be conveniently performed without spending labor or time to match the nozzle openings 11 of the head 10A and the predetermined position of the base portion 20A by use of a CCD camera or the like.

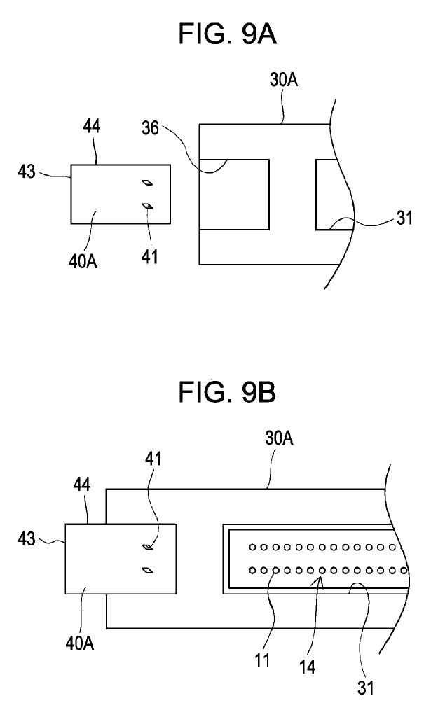

Next, a method for fabricating the head 10A and the head unit 1A according to the embodiment will now be described. FIGS. 9A and 9B are schematic views illustrating the method of fabricating the head and the head unit according to the second embodiment of the invention.

First, as shown in FIG. 9A, a photoresist pattern is formed on the surface of the positioning plate 40A in order to form the positioning adjusting hole 41 and the positioning planes 43 and 44 at the predetermined positions, and then is etched. After that, the photoresist pattern is removed to form the positioning adjusting hole 41 and the positioning planes 43 and 44 in the positioning plate 40A.

Next, as shown in FIG. 9B, the head case 15 receiving the head body 12 and the flow channel member 13 is fixed to the sub-plate 30A by inserting the head case 15 into the head inserting hole 31, in the state in which the nozzle openings 11 side protrudes toward the leg portion 33 side. Additionally, the sub-plate 30A is provided with a concave portion 36, to which the positioning plate 40A is attached, at one side thereof in a longitudinal direction. The length of the concave portion 36 in the first direction is set to be shorter than that of the positioning plate 40A. Moreover, the depth of the concave portion 36 is set to be equal to that of the positioning plate 40A.

Next, the head 10A is formed by attaching the positioning plate 40A to the concave portion 36 of the sub-plate 30A so that the positioning adjusting hole 41 and the nozzle openings 11 have a predetermined arrangement. More specifically, the CCD camera captures an image of the positioning adjusting hole 41 and the nozzle openings 11, and the centers of the positioning adjusting hole 41 and the nozzle openings 11 are obtained from the obtained image through an image process. The position of the positioning plate 40A is adjusted in order to position the centers of the positioning adjusting hole 41 and the nozzle openings 11 at predetermined positions.

Consequently, the positioning adjusting hole 41 and the nozzle openings 11 are positioned in the predetermined arrangement. Further, since the relative position between the positioning adjusting hole 41 and the positioning planes 43 and 44 is formed with high precision by the photolithographic method, the nozzle openings 11 and the positioning planes 43 and 44 are positioned with high precision in the predetermined arrangement.

Next, although not particularly shown, the base plate 20A is provided with the positioning convex portion 22A so that each of the heads 10A is positioned in the predetermined arrangement, and the positioning planes 43 and 44 are abutted against the reference planes 25 and 26 by inserting the nozzle openings 11 side of the head 10A into the through-hole 21. In this instance, the head 10A is fixed to the base plate 20A by using the fixing screw 35 to form the head unit 1A. As a result, the nozzle openings 11 are arranged with high precision at the predetermined position of the base plate 20A, and the nozzle openings 11 of the respective heads 10A are retained and arranged at the relative interval between the respective heads 10A.

### Other Embodiments

Although the embodiments of the invention are described above, the basic configuration of the invention is not limited to the above description.

Two lines of nozzle lines 14 are installed in the respective heads 10 and 10A in the above-described first and second embodiments, but the invention is not particularly limited thereto. For example, one line of the nozzle line 14 may be formed in the respective heads 10 and 10A, or three or more lines may be formed.

Further, in the above-described first and second embodiments, the head group 110 is constituted by four heads 10 and 10A, but the invention is not particularly limited thereto. The head group 110 may be constituted by two or more heads 10 and 10A.

In addition, two head groups 110 are installed in the head units 1 and 1A in the above-described first and second embodiments, but the invention is not particularly limited thereto. One head group 110 may be provided, or three or more head groups 110 may be provided. In addition, the head units 1 and 1A may be provided with one head 10 and 10A, respectively.

Further, the heads 10 and 10A include the sub-plates 30 and 30A, respectively, in the above-described first and second embodiments, but the invention is not particularly limited thereto. The positioning plates 40 and 40A are attached to a member constituting the heads 10 and 10A, such as the head case 15 or the flow channel member 13, and the heads 10 and 10A may be positioned and fixed to the base plates 20 and 20A, respectively.

Furthermore, the head units 1 and 1A can be applied to a so-called line type recording apparatus which can record only by transporting a recording medium to be recorded in the second direction, if the head unit is fixed to an apparatus body thereof in such a way that the second direction coincides with a transportation direction of a recording medium to be recorded, such as substrate or recording paper of a liquid ejecting apparatus which is represented by an ink jet type recording apparatus.

In this instance, the liquid ejecting apparatus is not particularly limited thereto, and, for example, by mounting the head units 1 and 1A on a moving unit, such as a carriage, which is movable in a direction perpendicular to the transport direction of the recording medium to be recorded, it can print the recording medium to be recorded having a width wider than the length of the nozzle line 14, which is continuous in the first direction, formed by the head group 110 of the head units 1 and 1A. That is, a relatively large recording medium to be recorded can be recorded by disposing the head units 1 and 1A in such a way that the first direction coincides with the transport direction of the recording medium to be recorded, and moving the head units 1 and 1A in the second direction and simultaneously moving the recording medium to be recorded in the first direction to perform the recording.

Of course, the number of the head units 1 and 1A mounted on the liquid ejecting apparatus is not particularly limited, and a plurality of head units 1 and 1A may be mounted on the liquid ejecting apparatus.

What is claimed is:

1. A method for fabricating a liquid ejecting head unit including a liquid ejecting head having a nozzle line with a plurality of nozzle openings which are arranged in parallel, and a base plate on which the liquid ejecting head is mounted, the method comprising:
forming a second reference which is positioned to a first reference installed on the base plate, and a positioning adjusting hole on a positioning plate by a photolithographic method;
attaching the positioning plate to the liquid ejecting head in such a way that the positioning adjusting hole and the nozzle openings have a predetermined arrangement; and
fixing the liquid ejecting head to the base plate in a state in which the first reference and the second reference are positioned.

2. The method for fabricating the liquid ejecting head according to claim 1, wherein in the step of attaching the positioning plate, the plurality of positioning plates are respectively attached to the plurality of liquid ejecting heads, and
in the step of fixing the liquid ejecting head, the liquid ejecting head is fixed to the base plate in the state in which the second reference is positioned to each of the plurality of first references installed on the base plate.

3. The method for fabricating the liquid ejecting head according to claim 1, wherein in the step of forming the second reference and the positioning adjusting hole, two positioning adjusting holes are formed in an edge portion of the positioning plate by the photolithographic method so that the positioning adjusting holes are opposite to each other across a center of the positioning plate.

4. The method for fabricating the liquid ejecting head according to claim 1, wherein the first reference is a positioning pin installed on a surface of the base plate, and
in the step of forming the second reference and the positioning adjusting hole, a through-hole inscribed in an outer circumference of the positioning pin is formed as the second reference in the positioning plate, in which the positioning adjusting hole is formed to have a diameter narrower than that of through-hole.

5. The method for fabricating the liquid ejecting head according to claim 1, wherein in the step of forming the second reference and the positioning adjusting hole, a surface abutting against the first reference is formed as the second reference on the positioning plate.

6. A liquid ejecting head having a nozzle line with a plurality of nozzle openings which are arranged in parallel, the liquid ejecting head comprising:
a positioning plate in which a second reference which is positioned to a first reference installed on a base plate, and a positioning adjusting hole are formed by a photolithographic method,
wherein the positioning adjusting hole and the nozzle openings of the positioning plate have a predetermined arrangement.

7. A liquid ejecting head unit comprising the plurality of liquid ejecting heads according to claim 6 which is mounted on the base plate.

8. A liquid ejecting apparatus comprising the liquid ejecting head unit according to claim 7.

9. A method for fabricating a liquid ejecting head having a nozzle line with a plurality of nozzle openings which are arranged in parallel, the method comprising:
forming a second reference which is positioned to a first reference installed on a base plate, on which the liquid ejecting head is mounted, and a positioning adjusting hole on a positioning plate by a photolithographic method; and
attaching the positioning plate to the liquid ejecting head so that the positioning adjusting hole and the nozzle openings have a predetermined arrangement.
